(19) United States
(12) Patent Application Publication
(10) Pub. No.: US 2025/0299476 A1
(43) Pub. Date: Sep. 25, 2025

(54) CURVATURE SELECTIVE CONVOLUTION FILTERS FOR VISUAL PROCESSING OF CONTIGUOUS AND OUTLINE SHAPES

(71) Applicant: Carl Steven Gold, Albany, CA (US)

(72) Inventor: Carl Steven Gold, Albany, CA (US)

(21) Appl. No.: 18/610,341

(22) Filed: Mar. 20, 2024

(51) Int. Cl. G06V 10/82

(52) U.S. Cl. CPC G06V 10/82

(57) ABSTRACT

Systems and methods for configuring and training neural networks for visual processing tasks, specifically focusing on higher-order feature selectivity with techniques to preconfigure higher-order features into convolutional neural networks (CNNs) when the input image may contain shapes defined by either outlines or contiguous regions of high or low intensity. This includes creating a topographically organized layer of orientation-selective neurons that collectively detect multiple orientations of either lines or edges of high or low intensity in an image patch. Additionally, a pooling layer may aggregate the oriented line and edge detection layer into units selective to orientation of any type in an image patch. The method further extends to configuring an artificial neural network to be selective to contours comprising curved sections and straight or nearly straight sections.

### CROSS-REFERENCE TO RELATED APPLICATIONS

This application claims priority to and incorporates by reference the entire disclosure of U.S. patent application Ser. No. 18/309,831, filed on May 1, 2023

### BACKGROUND

### Field

Certain aspects of the present disclosure generally relate to neural system engineering, and more particularly to systems and methods for configuring and/or training neural networks for classification and other visual processing tasks.

### Background

The last several years have seen significant advances in the application of artificial neural networks to machine learning problems. Examples include the application of neural networks to visual classification tasks, auditory classification tasks, and the like, for which artificial neural networks have achieved state-of-the-art performance.

However, artificially intelligent systems continue to fail at tasks that are easy even for infants, such as learning a category from only one or a few examples.

Furthermore, in the view of many neuroscientists, however, this progress has not translated into increased understanding of biological intelligence. In addition, principles of biological neural networks have not informed the design of artificial neural networks in many respects.

Current state-of-the-art neural networks include techniques for configuring useful convolutional kernels corresponding to low-level feature selectivity of a biological visual system. For example, convolutional neural networks may be configured to detect oriented edges. However, higher-order features that may be detected by higher-level biological neural networks have not been preconfigured into artificial neural networks. Accordingly, techniques are disclosed herein whereby useful higher-order features of perceptual stimuli, such as curved paths having a variety of arcs and sizes, may be preconfigured into a convolutional neural network.

### SUMMARY

Certain aspects of the present disclosure generally relate to providing, implementing, and using a method of configuring convolutional neural networks without training the model on data. According to certain aspects, a visual data classification network may be configured such that much of the training typically associated with neural network design may be avoided.

The method generally includes configuring an artificial neural network to be selective to contours including curved sections and straight or nearly straight sections.

The artificial neuron network comprises a first topographically organized layer of orientation-selective neurons. And wherein each orientation-selective neuron of a subset of the orientation-selective neurons is selective to a regular intensity oriented line of inputs having some width in an image patch, and wherein the subset of the orientation-selective neurons is collectively selective of a plurality of regular intensity line orientations in the image patch.

The method further includes in the first topographically organized layer of orientation-selective neurons wherein each orientation-selective neuron of a subset of the orientation-selective neurons is selective to an oriented edge of a given size from a contiguous shape in an image patch, and wherein the subset of the orientation-selective neurons is collectively selective of a plurality of edge orientations in the image patch.

The method further includes in the first topographically organized layer of orientation-selective neurons wherein each orientation-selective neuron of a subset of the orientation-selective neurons is selective to an inverse-intensity oriented line of inputs having some width in an image patch, and wherein the subset of the orientation-selective neurons is collectively selective of a plurality of inverse intensity line orientations in the image patch.

The method further includes creating a second topographically organized layer of pooling neurons wherein each orientation-selective pooling neuron of a subset of the orientation-selective pooling neurons is selective to any form of oriented feature in an image patch including lines of varied widths, edges of varied sizes and inverse intensity lines of varied widths. Each orientated pooling neuron is configured to respond to any form of oriented feature sharing the same orientation by selection of inputs from orientation-selective neurons from the first topographically organized layer, wherein excitatory weights are configured for selected inputs respond to features aligned with the orientation of the pooling unit.

The method further includes creating a third topographically organized layer of neurons selective for curve segments as described in the parent application. Each curve-segment-selective neuron is configured to respond to a set of generalized oriented features in the image patch by selection of inputs from orientation-selective pooling neurons from the second topographically organized layer, wherein excitatory weights are configured for selected inputs that are selective for generalized oriented features that form the curve segment and have positions and orientations that match the curve segment, with inputs of other orientations and locations configured to have less weight including inhibition.

The method further includes creating an approximately-straight-selective neuron, as described in the parent application.

The method further includes creating curve-selective neurons, as described in the parent application.

The method further includes curve-selective neurons wherein the curve-selective neuron is selective to a curve having a specified center, a specified degree of curvature, and a specified orientation, and the curve selectivity has a form of symmetry with respect to the center of the receptive field such as circular or elliptical symmetry. The symmetric curve-selective neuron has as input an output of the topographically organized layer of curve-segment-selective neurons, in which the curve-selective neuron responds to the specified degree of curvature and at the specified orientation relative to the specified center by selection of inputs from curve-segment-selective neurons having an orientation that is determined systematically based on the position of the input in relation to the center, and wherein the selection of inputs has a form of symmetry with respect to the center of the respective field, and wherein the selection is further based on a correspondence between the specified degree of curvature and a corresponding property for which individual input curve-segment-selective neurons are selective.

The method further includes curve-selective neurons wherein the curve-selective neuron is selective to a curve having a specified center, a specified degree of curvature, and a specified orientation, and the curve selectivity is asymmetrical with respect to the center of the receptive field, or symmetrical only to 360° rotation. The asymmetric curve-selective neuron has as input an output of the topographically organized layer of curve-segment-selective neurons, in which the curve-selective neuron responds to the specified degree of curvature and at the specified orientation relative to the specified center by selection of inputs from curve-segment-selective neurons having an orientation that is determined systematically based on the position of the input in relation to the center, and wherein the selection of inputs is asymmetrical with respect to the center of the respective field, and wherein the selection is further based on a correspondence between the specified degree of curvature and a corresponding property for which individual input curve-segment-selective neurons are selective

The method may include creating additional layers of selective neurons to perform higher level detection tasks using curve selective and nearly-straight line selective units as inputs. Higher level detection tasks may be performed by additional units configured without training, or by units trained to perform higher levels.

### BRIEF DESCRIPTION OF DRAWINGS

FIG. 1 illustrates convolution filters that have selectivity for short line segments having a variety of widths and at a variety of orientations, in accordance with certain aspects of the present disclosure.

FIG. 2 illustrates convolution filters that have selectivity for short, oriented segments at the edge of a contiguous shape at a variety of orientations, in accordance with certain aspects of the present disclosure.

FIG. 3 illustrates convolution filters that have selectivity for short line segments of inverted intensity at a variety of orientations, in accordance with certain aspects of the present disclosure.

FIG. 4 illustrates pooling convolution filters that combine edges and line segments of both regular and inverted intensity into filters sensitive generalized oriented shapes that may be either outlined or contiguous of regular or inverted intensity, in accordance with certain aspects of the present disclosure.

FIG. 5 illustrates a pattern of connections that may be configured to generate asymmetrical selectivity for curvature in regions of an image, in accordance with certain aspects of the present disclosure.

FIG. 6 illustrates multiple layers of a neural network corresponding one possible embodiment of the present disclosure.

FIG. 7 illustrates the response to a shape outline in accordance with certain aspects of the present disclosure.

FIG. 8 illustrates the response to a shape outline consisting of inverted intensity in accordance with certain aspects of the present disclosure.

FIG. 9 illustrates the response to a contiguous shape in accordance with certain aspects of the present disclosure.

FIG. 10 illustrates the response to a contiguous shape of inverted intensity in accordance with certain aspects of the present disclosure.

### DETAILED DESCRIPTION

Current state-of-the-art neural networks include techniques for configuring useful convolutional kernels based on properties of biological neurons. To date, however, such techniques have only been applied that emulate low-level feature selectivity of a biological visual system.

Accordingly, U.S. patent application Ser. No. 18/309,831 disclosed techniques whereby higher-order features of perceptual stimuli detected by neurons (such as those found in V4) may be preconfigured into a convolutional neural network.

For processing certain images, it may be useful for feature recognizing units to respond in a similar fashion to the curved and straight segments of a shape without regard to how the shape is defined against the image background.

A shape may be defined against an image background by a high intensity outline against a low intensity background as disclosed in U.S. patent application Ser. No. 18/309,831. Furthermore, a shape may be defined by lines having a variety of linewidths.

A shape may also be defined by a contiguous region of either high intensity against a low intensity background or a contiguous region of low intensity against a high intensity background, or by a low intensity outline against a high intensity background.

Furthermore, U.S. patent application Ser. No. 18/309,831 disclosed techniques for creating feature recognizing units in a convolution neural network to respond to different degrees of curvature wherein the curvature selectivity has symmetry with respect to the center of the receptive field.

For processing certain images, it may be useful to have feature recognizing units in a convolution neural network to respond to different degrees of curvature wherein the curvature selectivity is asymmetrical with respect to the center of the receptive field.

### Selectivity for Line Segments of Variable Linewidth

U.S. patent application Ser. No. 18/309,831 disclosed how convolutional neural network may be configured to have units that are selective for short line segments having a particular width and consisting of high intensity stimulus against a background of low intensity stimuli at a variety of orientations in a small region of an image.

A convolutional network may be configured to have units that are selective for short line segments of high intensity having a variety of linewidths at a variety of orientations in a small region of an image.

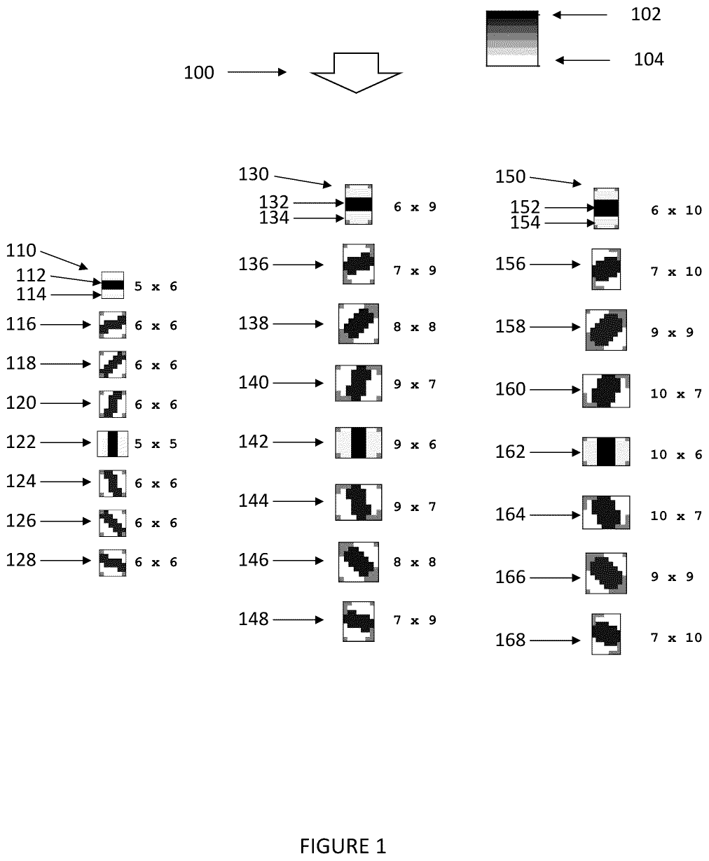

The principle of such variable linewidth filters is the same as those disclosed in FIG. 1 of the parent application with varying sizes of the filter and the excitatory and inhibitory regions. FIG. 1 of the present application illustrates the principle simply.

In FIG. 1 of the present application the input 100 to the convolution filter at this stage is the intensity of the image at each position. This constitutes a single channel of inputs—for each position in the input image, a single real value summarizes the information about that location and is fed into the layer.

The filters may have excitatory 102 and inhibitory 104 regions.

A convolution filter 110 may be configured to be selective of lines having width of 2 pixels. Such a filter is applied in a small region of an image, also known as a patch, or image patch. Filter 110 covers a patch in a receptive field of 5×6 pixels.

An excitatory weighted strip having a width of 2 pixels 112 may be centered in the filter and surrounded by inhibitory strips having width 2 pixels each 114. The excitatory strip 110 may be oriented horizontally and as a result units based on this the filter may respond to horizontally oriented lines segments 2 pixels wide in the patches of an image to which it is applied.

Similar methods may be used to create units with selectivity for short, 2-pixel wide oriented lines at a variety of orientations. For example, units may respond to lines oriented at 22.5° (116), 45° (118), 67.5° (120), 90° (122), 112.5° (124), 135° (126) and 157.5° (128).

Another convolution filter 130 may be configured to be selective of lines having width of 3 pixels. Such a filter is applied in a small region of an image, also known as a patch, or image patch. Filter 110 covers a patch in a receptive field of 6×9 pixels.

An excitatory weighted strip having a width of 3 pixels 132 may be centered in the filter and surrounded by inhibitory strips having width 3 pixels each 134. The excitatory strip 132 may be oriented horizontally and as a result units based on this the filter may respond to horizontally oriented lines segments 3 pixels wide in the patches of an image to which it is applied.

Similar approaches may be used to create units with selectivity for short, 3-pixel wide oriented lines at a variety of orientations. For example, units may respond to lines oriented at 22.5° (136), 45° (138), 67.5° (140), 90° (142), 112.5° (144), 135° (146) and 157.5° (148).

Similar methods may be used to create units with selectivity for short, 4-pixel wide oriented lines at a variety of orientations which is shown in FIG. 1, 150-168. The details of selectivity for other width lines is omitted for brevity.

The output of each width and orientation of line selective units at a variety of locations tiling the visual space may be considered as separate channels of inputs in the later layer.

In FIG. 1 the receptive fields are defined to correspond to that of a biological neuron by having an circularly shaped region of excitatory and inhibitory connections and zero outside the elliptical receptive field. In other embodiments the receptive field may be defined to be rectangular or other shapes.

### Edge Selectivity

U.S. patent application Ser. No. 18/309,831 disclosed how convolutional neural network may be configured to have units that are selective for short line segments of high intensity stimulus against a background of low intensity stimuli at a variety of orientations in a small region of an image.

A convolutional neural network may be configured to have units that are selective for short segments on the edge of a contiguous shape at a variety of orientations in a small region of an image.

Creating convolution filters responsive to small edge segments may be accomplished by a variety of means without the use of training data. One well-known approach is to use Gábor filters.

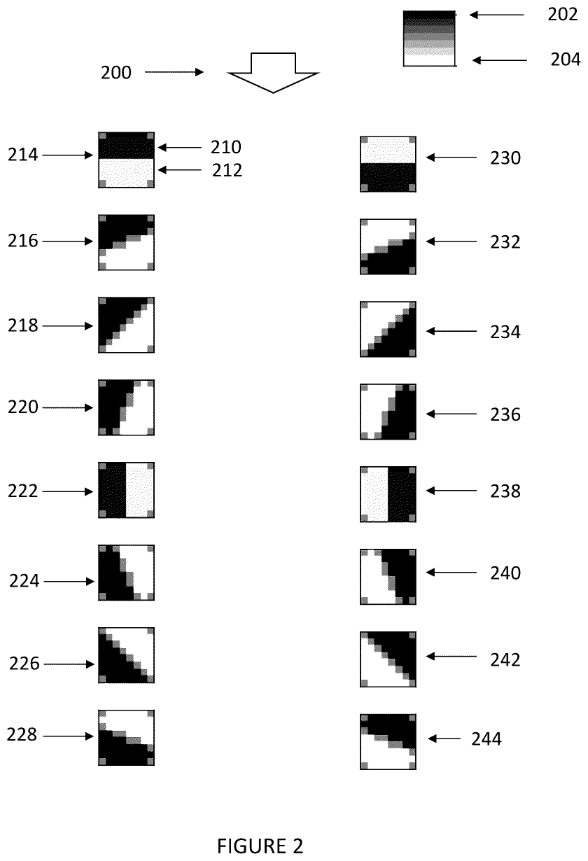

FIG. 2 illustrates the basic principle simply. The input 200 to the convolution filter at this stage is the intensity of the image at each position. This constitutes a single channel of inputs—for each position in the input image, a single real value summarizes the information about that location and is fed into the layer.

The filters have excitatory 202 and inhibitory 204 regions.

A convolution filter 214 may cover a small region of an image, also known as a patch, or image patch.

In a single filter 214 an excitatory weighted portion 210 may cover one half of the filter and the other half may be weighted to less excitation including inhibition 212. The boundary between the excitatory and inhibitory zones may be oriented horizontally and as a result units based on this the filter may respond to contiguous zones of high intensity above the horizontal boundary with low or no intensity below the boundary.

The same approach may be used to create units with selectivity for short, oriented edges of contiguous shapes at a variety of orientations. For example, units may be configured to respond to edges of contiguous shape on the top half of the boundary oriented at 22.5° (216), 45°(218) or 67.5° (220); and units may be configured to respond to a contiguous shape on the left half of the image patch with a boundary at 90° (222), 112.5° (224), 135° (226) and 157.5° (228).

The same approach may be used to create units with selectivity for short, oriented edges of a contiguous shape on either side of the image patch. For example, units may respond to edges of a contiguous patch in the bottom half of an image patch with the boundary horizontal, at 0°, (230) or with a boundary at 22.5° (232), 45° (234) or 67.5° (236); and units may be configured to respond to a contiguous shape on the right half of the image patch with a boundary at 90° (238), 112.5° (240), 135° (242) and 157.5° (244).

As the filters cover small image patches and are symmetric to 180° rotation the same approach may be used to create units with selectivity for boundaries of contiguous shapes in which the shape consists of a region of low intensity in the image surrounded by a region of high intensity: The filter 214 may respond either to a high intensity contiguous shape against a low intensity background where the high intensity is above the horizontal, or a low intensity shape against a high intensity background where the low intensity is below the horizontal. Similarly, any of the filters in FIG. 2 may be useful for detecting the edges of shapes of either high intensity against a low intensity background or low intensity against a high intensity background.

In FIG. 2 the receptive fields are defined to correspond to that of a biological neuron by having an circularly shaped region of excitatory and inhibitory connections and zero outside the elliptical receptive field. In other embodiments the receptive field may be defined to be rectangular or other shapes.

The output of each orientation of edge selective units at a variety of locations tiling the visual space may be considered as separate channels of inputs in the later layer.

Similar methods may be used to create edge selective filters for shapes having different sizes in an image by scaling the size of the edge selective neurons receptive field. Such methods were illustrated for line segment selective filters in FIG. 1. Description of such filters is omitted for brevity.

### Inverted Intensity Line Selectivity

U.S. patent application Ser. No. 18/309,831 disclosed how convolutional neural network may be configured to have units that are selective for short line segments of high intensity stimulus against a background of low intensity stimuli at a variety of orientations in a small region of an image.

Convolution filters may be configured to respond to lines of low intensity against a high intensity background, which may be referred to as line segments of inverted intensity. The principle of such filters is similar to those disclosed in U.S. patent application Ser. No. 18/309,831 for lines of high intensity against a low intensity background but with the role of excitation and inhibition inverted.

The input 300 to the convolution filter at this stage is the intensity of the image at each position. This constitutes a single channel of inputs—for each position in the input image, a single real value summarizes the information about that location and is fed into the layer.

The input representing an image patch 300 may be processed by a variety of filters that have excitatory 302 and inhibitory 304 regions.

An inhibitory weighted strip 314 may be centered in the filter and surrounded by excitation 310. The inhibitory strip 314 may be oriented horizontally and as a result units based on this the filter may respond to horizontally oriented lines segments of low intensity against a high intensity background: If the background is solid and of high intensity, then the high intensity activates both the excitatory and inhibitory regions, and the inhibitory region may prevent firing. But if the filter receives as input an image patch with a high intensity overall and a line of low intensity at its center, the low intensity matches the placement of the inhibition, the resulting inhibition of the unit is reduced, and the unit may fire.

The same approach may be used to create units with selectivity for short, oriented lines of inverted intensity at a variety of orientations. For example, units may respond to lines oriented at 22.5° (316), 45° (318), 67.5° (320), 90° (322), 112.5° (324), 135° (326) and 157.5° (328).

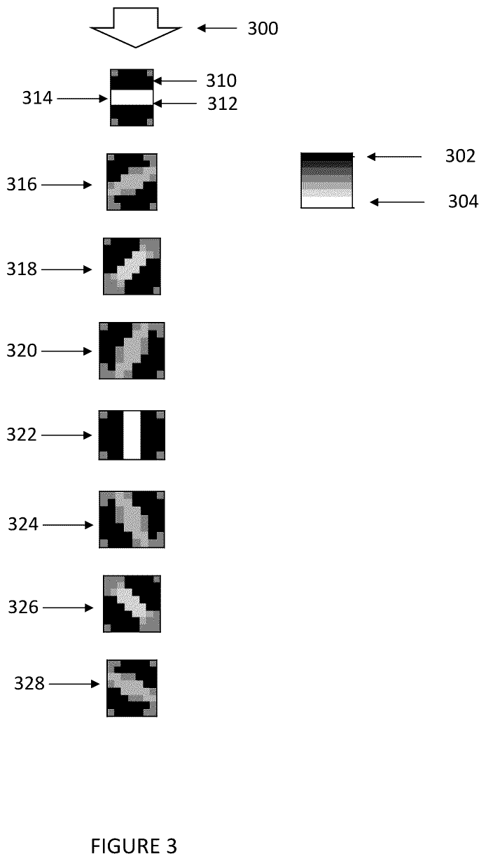

In FIG. 3 the receptive fields are defined to correspond to that of a biological neuron by having an elliptically shaped region of excitatory and inhibitory connections and zero outside the elliptical receptive field. In other embodiments the receptive field may be defined to be rectangular or other shapes.

The output of each orientation of inverted intensity line selective units at a variety of locations tiling the visual space may be considered as separate channels of inputs in the later layer.

Similar methods may be used to create line selective filters for line segments of inverted intensity having different widths as illustrated in FIG. 1 for line segments of ordinary intensity. Description of such filters is omitted for brevity.

### Combined Line and Edge Selectivity

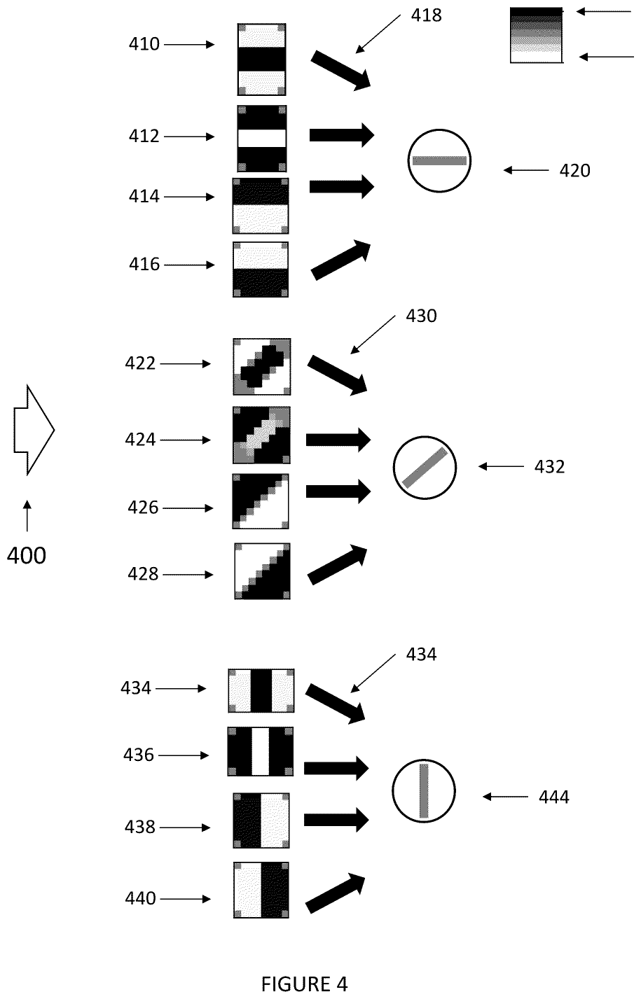

FIG. 4 illustrates the method by which units responsive to lines and edges may be combined with a filter that is sensitive to either an edge or a line of either ordinary or inverted intensity at a particular orientation.

The input representing an image patch 400 may be processed by a variety of filters that have excitatory (402) and inhibitory (404) regions.

There may be input channels of units like those described in FIG. 1 of the parent application (U.S. patent application Ser. No. 18/309,831) and FIG. 1 of the present application that respond to lines at horizontal orientation (410). These may constitute multiple channels of inputs, corresponding to each orientation of the filters.

There may be input from channels of units like those described in FIG. 2 of the present application that respond to edges of contiguous shapes with a horizontal orientation, with the contiguous shape either above the horizontal (414) or below the horizontal (416).

There may be inputs from channels like those described in FIG. 3 of the present application that respond to line segments of inverted intensity and having horizontal orientations 412.

The output of multiple types of units sensitive to different varieties of horizontal shape boundaries (410, 412, 414, 416) may be combined (418) in a unit that may be sensitive to any type of horizontal boundaries (420).

The combination of units (418) may be instantiated through a variety of possible methods. In one possible instantiation, the combination method is an “OR” operation in which the unit sensitive to any type of horizontal boundary activates if any one of the inputs is activated.

In another possible instantiation, each of the input of the combination units (418) has a weight which may meet or exceed the threshold of the unit such that it may activate when any one of the input units (410, 412, 414,416) is activated.

The combination unit may also perform a pooling operation like as is commonly found in convolutional neural networks, meaning that the unit way receiver input from multiple line and edge selective units at neighboring locations in the topographically organized input channel.

In another possible instantiation, the input of the combination units (418) has a weight that individually does not exceed the threshold such that it may activate when more than one of the input units (410, 412, 414,416) at one or more pooled locations is activated.

Similar methods may be used to include line and edge selective filters having different sizes. Line and edge selective filters having different sizes were omitted from FIG. 4 for clarity.

Similar methods may be used to creative filters selective for either lines or edges at a 45° angle (422-432). Similar methods may be used to create filters selective for either lines or edges at a 90° angle (434-444). Similar methods may be used to create filters selective for other orientations of either lines or edges which are omitted for brevity.

### Asymmetric Curvature Selectivity

Neurophysiological observations suggest that visual area V4 may contain neurons that are sensitive to different degrees of curvature in patches of an image (Pasupathy & Connor, Shape Representation in Are V4: Position Specific Tuning for Boundary Conformation, 2001). These selectivities may be for either convex or concave curvature of different degrees, and the selectivity of one unit may be in either a symmetric or an asymmetric range of positions around the center of the receptive field of the curve selective unit.

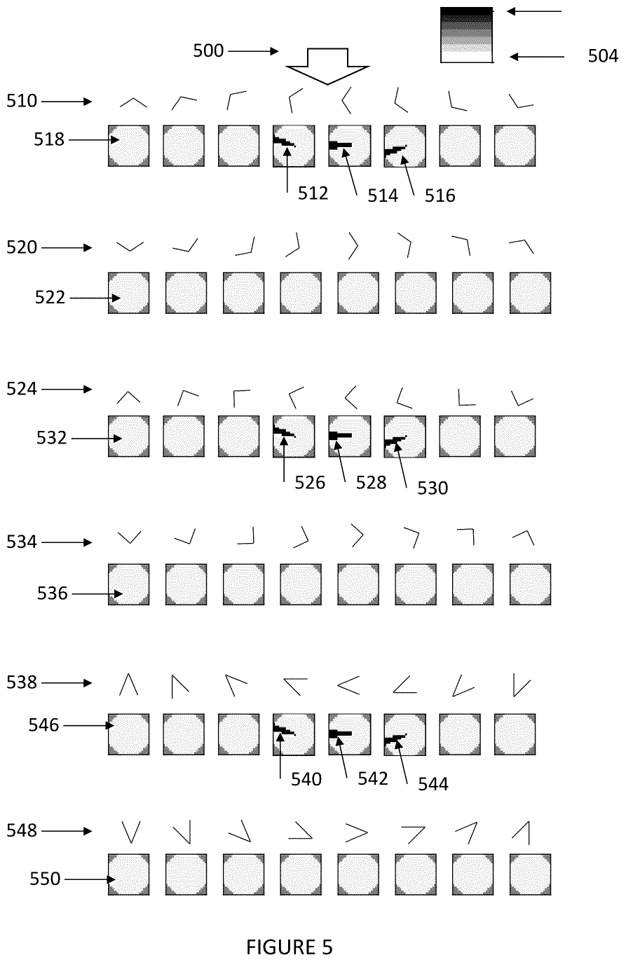

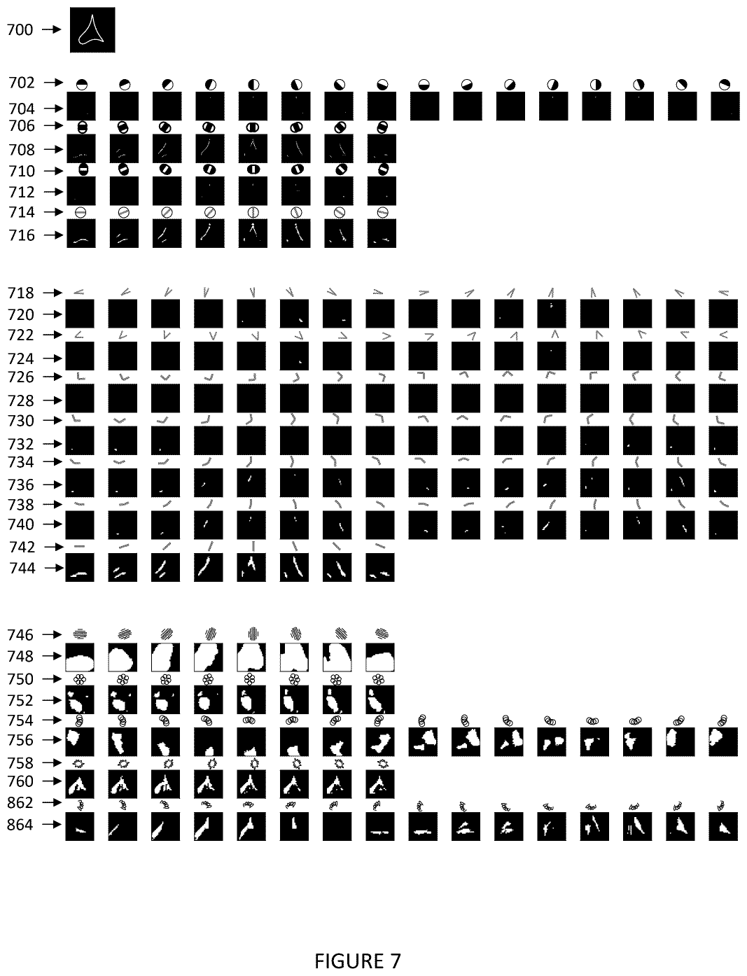

FIG. 5 of the parent application and FIG. 7 of the parent application disclosed embodiments of curvature selective filters that are symmetric around the center of the receptive field.

FIG. 5 of the present application illustrates certain aspects of the present disclosure, in which convolution weights may be configured to respond selectively to curvatures over an asymmetric portion of the receptive field, such as selectivity to curvature to the left of center of the receptive field. The embodiment of selectivity for curvature in FIG. 5 of the present application s is asymmetric, while the curvature selectivity in the embodiments of FIG. 5 in the parent application and FIG. 7 in the parent application are symmetric.

In FIG. 5 of the present application the inputs to the convolution filters 500 are the outputs of channels in the previous layer of the network. For example, when a applied to a neural network that has layers with properties corresponding to the layers illustrated in FIG. 2 of the parent application, there may be 48 channels of inputs, such as are illustrated in rows 510, 520, 524, 534, 538, and 548 of FIG. 5 of the present application where each illustrated input corresponds to one orientation of one corner selective unit from the layer corresponding to FIG. 2 of the parent application. FIG. 5 of the present application shows pictograms of the preferred stimuli like 242, 244 246 and 248 of the parent application and includes other channels from the preceding layer that were omitted from FIG. 2 of the parent application for brevity.

FIG. 5 of the present application illustrates the input channels 510, 520, 524, 534, 538, and 548 from a previous layer in a convolutional neural network, drawn at a particular location corresponding to a row and column index. These channels may include units sensitive to lines forming 112.5° corners at a variety of orientations 510 and 520, and lines forming 90° corners at a variety of orientations 524 and 534, and lines forming 67.5° corners at a variety of orientations 538 and 548.

The input channels illustrated in rows 510, 520, 524, 534, 538, and 548 may be considered grouped by orientation column-wise. This row-by-column arrangement may facilitate configuration of unit selectivity in this layer. The neural network layer may be configured to have excitative or inhibitory connections to channels near the same orientation, and at the same time selective for a range of corner angles.

The convolution filters of FIG. 5 may include excitatory 502 and inhibitory 504 weights on inputs from previous layers.

FIG. 5 shows that there may be excitatory connections 512, 514 and 516 from 112.5° corner selective units having an orientation that changes throughout the receptive field depending on the angle in relation to the center of the receptive field and these excitatory connections may cover over only a small range of angles around the center of the receptive field. For example, the locations of the excitatory zones 512, 514 and 516 are to left of the center, and they may form excitatory connections to inputs selective for corners that open to the right. Other locations and orientations 518 and 522 may be inhibited.

FIG. 5 shows there may also be excitatory connections from units selective to 90° corners that open to the right 526, 528, and 530 and also excitatory connections from units selective to 67.5° corners that open to the right 540, 542 and 544. Other locations and orientations of inputs in the receptive fields may be inhibited 532, 536, 546 and 550.

As a result of this configuration the embodiment of FIG. 5 will respond selectively to curvatures over a small range of positions, such as selectivity to curvature to the left of center of the receptive field.

In FIG. 5, the selectivity of the input channels is illustrated as tuned for angles or corners in a small range of positions relative to the receptive field. In other embodiments the input channels may be selective for curved segments with different arcs and shapes.

In FIG. 5, the selectivity of the input channels is illustrated as excitatory for curvatures that are convex in orientation to the center of the receptive field. In other embodiments the input channels may be concave with respect to the center of the receptive field.

In FIG. 5 the receptive fields are defined to correspond to that of a biological neuron by having a circular shaped region of excitatory and inhibitory connections and zero outside the circular receptive field. In other embodiments the receptive field may be defined to be rectangular or other shapes.

### Embodiment of Curvature and Nearly Straight-Line Selectivity Combining Line and Edge Selectivity

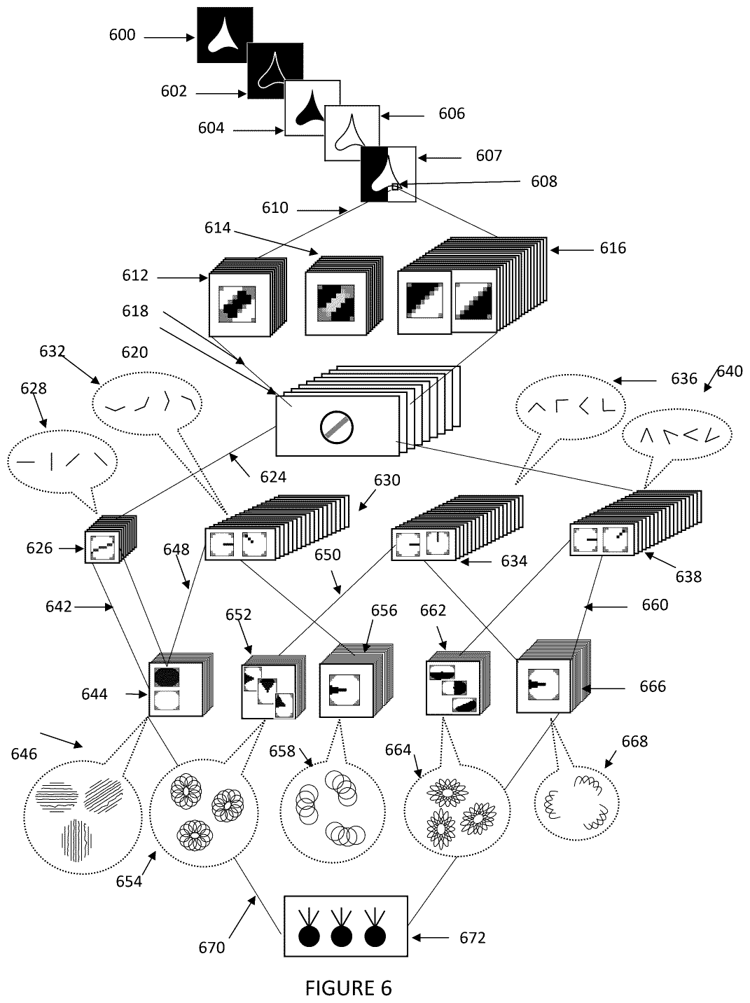

FIG. 6 illustrates one possible embodiment of the present disclosure wherein there are curvature selective and straight or nearly straight line selective convolution filters for both outlines and contiguous shapes of either regular intensity, inverted intensity, or a combination thereof in a single image.

Inputs may include shapes represented with a high intensity contiguous form against a low intensity background 600, a high intensity outline against a low intensity background 602, a low intensity contiguous shape against a high intensity background 604, a low intensity outline against a high intensity background 606, or a combination thereof 607.

The intensity values of a single patch of the image 608 are broadcast 610 to the orientation selective channels.

A channel consists of a pattern of selectivity at a given orientation that is applied simultaneously to all patches of the image.

Channels in the orientation selective layer may include neurons selective to short lines of ordinary intensity 612 like those described in FIG. 2 of the parent application and FIG. 1 of the present application.

The line segment selective filters may include line segment selective filters having a variety of widths as illustrated in FIG. 1. Line segment selective filters of varied withs are omitted from FIG. 6 for clarity.

Channels in the orientation selective layer may include neurons selective to short lines having inverted intensity 614 like those described in FIG. 3 of the present application.

Channels in the orientation selective layer may include edge selective neurons 616 like those described in FIG. 2 of the present application. As edge selective neurons are not symmetric to 180° rotation, there may be a larger number of channels for edge selectivity than line selectivity to accommodate the additional orientations.

The embodiment may include a pooling layer 620 like the one described in FIG. 4 of the present application consisting of neurons selective to a given orientation in a patch of the image. The pooling layer 620 may combine inputs 618 from multiple types of oriented units in the first layer having the same or similar orientation.

The embodiment depicted in FIG. 6 may include line and corner selective like those described in FIG. 2 of the parent application. There may be channels of units with convolution filters 626 selective for long straight lines at a variety of orientations 628.

The embodiment may include channels like those described in FIG. 2 of the parent application composed of units with convolution filters 630 selective to corners with an obtuse angle at a variety of orientations 632.

The embodiment may include channels like those described in FIG. 2 of the parent application composed of units with convolution filters 634 selective to right angles 636 at a variety of orientations.

The embodiment may include channels like those described in FIG. 2 of the parent application composed of units with convolution filters 638 that are selective to acute angles at a variety of orientations 640.

The straight-line selective channels may output 642 to channels 644 selective for straight or nearly straight lines 646 like those described in FIG. 4 of the parent application. As described in the parent application, the straight or nearly straight-line selective channels 644 may also take as input the output of slightly bent corner selective channels 648.

The output of slightly bent corner selective channels 648 along with the output of right-angle corner select channels 650 may be the input to channels selective for medium curvature that is concave to the center of each unit, 652 and 656, like those described in FIG. 5 of the parent application.

The embodiment may include channels of medium curve selective channels with units selective for medium concave curvature symmetrically around the center of the receptive field 652 like those described in FIG. 5 of the parent application, leading to a selectivity for medium curvature that has some form of symmetry (circular, elliptical, etc.) 654. When the receptive field is non-circular, the pattern may be translated at a variety of orientations in different channels.

The medium curvature selective channels may include channels of units 656 selective for medium degrees of concave curvature that is asymmetric like those described in FIG. 5 of the present application, having curvature selectivity over a range of positions around the center of the receptive field 658 at a variety of orientations.

The output of right-angle selective channels 650 and the output of acute angle selective channels 660 may serve as inputs to channels of units selective to high curvature that is concave with respect to the center of each unit, 662 and 666, like those described in FIG. 7 of the parent application.

The high curve selective channels may include units selective for concave high curvature symmetrically over an entire 360° range of rotations around the center of the receptive field 662 leading to a selectivity for high curvature that has some form of symmetry (circular, elliptical, etc.) 664. When the receptive field is non-circular, the pattern may be translated at a variety of orientations in different channels.

The high curvatures selective channels may include channels of units 666 selective for high degrees of concave curvature that is not symmetric around the center of the receptive field at a variety of orientations 668.

The output of all of the channels of nearly-straight line and curve selective filters 670 may be input to additional layers of neurons 672 that perform higher level detection tasks. Such additional layers of neurons may be configured prior to training or trained without configuration or both.

Alternative embodiments may include channels of units that have selective for convex curvature in the curvature selective layer, which is not shown in FIG. 6.

Alternative embodiments may include pooling units between the corner selective units and the approximately straight-line selective units, which is not shown in FIG. 6.

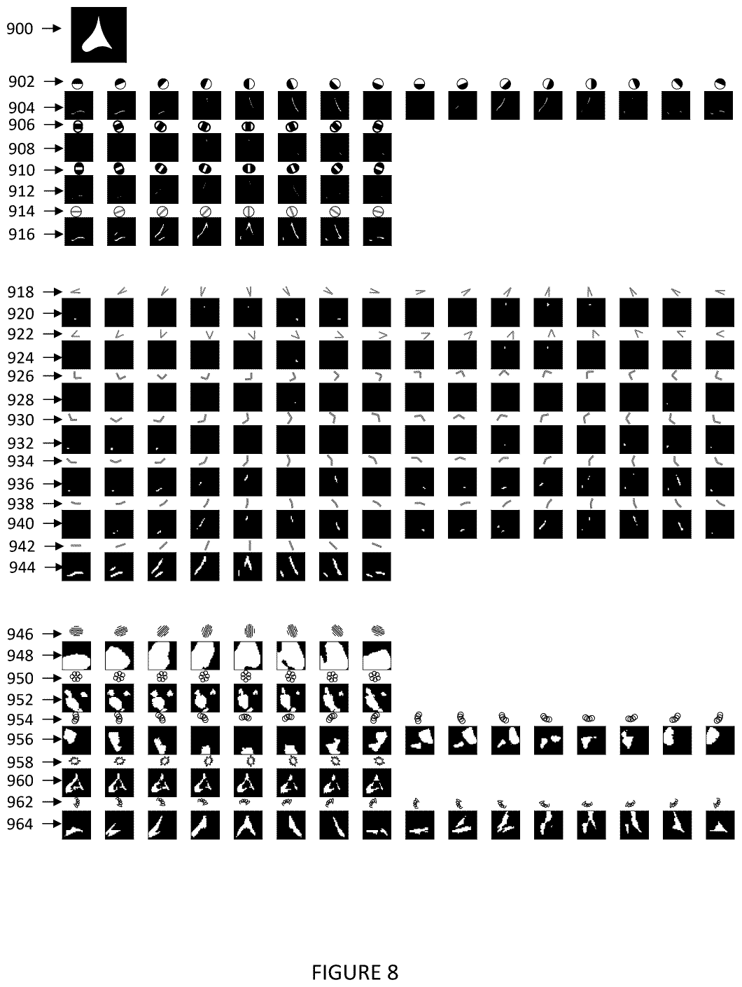

Alternative embodiment may include arc selective units like those in FIG. 9 of the parent application in addition to or in place of the corner selective units, which is not shown in FIG. 6.

### Curvature Selectivity to Both Outlines and Contiguous Shapes

FIG. 7 through FIG. 10 illustrate one possible behavior of an embodiment of the present disclosure as it responds to both outlines and contiguous shapes having both ordinary and inverted intensity.

FIG. 7 shows a shape outline of ordinary intensity 700: a high intensity (white) outline against a low intensity (black) background.

The embodiment of FIG. 7 through FIG. 10 may include edge detection units, of the kind described in FIG. 2 of the present disclosure, at 16 orientations. The pictograms in row 702 show the orientations of the edge detecting units. The output of these 16 channels 704 is shown under the pictograms of the corresponding unit. The outputs of the edge detecting units may be low response or none to the outline FIG. 700.

The embodiment of FIG. 7 through FIG. 10 may include line detection units of ordinary intensity, as described in the parent application FIG. 1 of the parent application and FIG. 2 of the present application, at 8 orientations 706. The output of these 8 channels is shown under the pictograms corresponding to each orientation in row 708.

The output of the line detection units 708 is substantially consistent with the shape of the input 700: Units of corresponding orientation respond at appropriate positions of the shape.

The embodiment of FIG. 7 through FIG. 10 may include line detection units of inverted intensity, of the kind described in FIG. 3 of the present disclosure, at 8 orientations indicated by the pictograms in row 710. The output of these 8 channels is shown under the corresponding pictograms in row 712. The line detection units having inverted intensity may be low response or none to the outline shape 700.

The embodiment of FIG. 7 through FIG. 10 may include a pooling layer that combines the line and edge channels of the same orientation as described in FIG. 4 of the present disclosure. There are 8 orientations of the pooling units as indicated by the pictograms 714.

The output of the 8 channels of pooling units in row 716 shows that units of corresponding orientation respond at appropriate positions of the shape.

The embodiment of FIG. 7 through FIG. 10 may include acute corner detection units similar to those shown in FIG. 2 of the parent application (parent application 242-248). The embodiment of FIG. 7 has two acute angle corner detection unit channels with corner angle 45° (pictograms row 718) and 67.5° (pictograms row 722). The output of these channels is shown in rows 720 and 724.

The embodiment of FIG. 7 through FIG. 10 may include a right-angle corner detection units like those shown in FIG. 2 of the parent application (parent application 228-234). The embodiment of FIG. 7 has 16 channels for different rotations of the right-angle corner detection unit as shown by the pictograms in row 726. The output of these channels is shown in row 728.

The embodiment of FIG. 7 through FIG. 10 may include obtuse corner detection units like those shown in FIG. 2 of the parent application (parent application 228-234). The embodiment of FIG. 7 has three obtuse angle corner detection unit channels with corner angle 112.5° (pictograms row 730) and 135° (pictograms row 734) and 157.5° (pictograms row 738). The output of these channels is shown in rows 732, 736 and 740 respectively.

The embodiment of FIG. 7 through FIG. 10 may include straight-line detection units like those shown in FIG. 2 of the parent application (parent application 214-220). The embodiment of FIG. 7 has 8 channels for different rotations of the straight-line detection unit as shown by the pictograms in row 742. The output of these channels is shown in row 744.

The embodiment of FIG. 7 may include straight or nearly straight-line detection units of the kind described in FIG. 4 of the parent application. The row of pictograms 746 shows 8 orientations of the straight or nearly straight-line detection units. The output of the channels of straight or nearly straight-line detection units is shown in row 748.

The embodiment of FIG. 7 through FIG. 10 may include symmetric medium curvature detection units of the kind described in FIG. 5 of the parent application. These units have an elongated receptive field and the row of pictograms 750 shows 8 orientations of these units. The output of the channels of medium curvature detection units is shown in row 752.

The embodiment of FIG. 7 through FIG. 10 may include asymmetric medium curvature detection units like those described in FIG. 5 of the present disclosure. The row of pictograms 754 shows the 16 orientations of the asymmetric medium curvature detection units. The output of the channels of the asymmetric medium curvature detection units is shown in row 756.

The embodiment of FIG. 7 through FIG. 10 may include symmetric high curvature detection units of the kind described in FIG. 7 of the parent application. These units have an elongated receptive field and the row of pictograms 758 show the 8 orientations of the symmetric high curvature detection units. The output of the channels of symmetric high curvature detection units is shown in row 760.

The embodiment of FIG. 7 through FIG. 10 may include asymmetric high curvature detection units like those shown in FIG. 5 of the present disclosure. The row of pictograms 762 shows the 16 orientations of the asymmetric high curvature detection units. The output of the channels of the asymmetric high curvature detection units is shown in row 764.

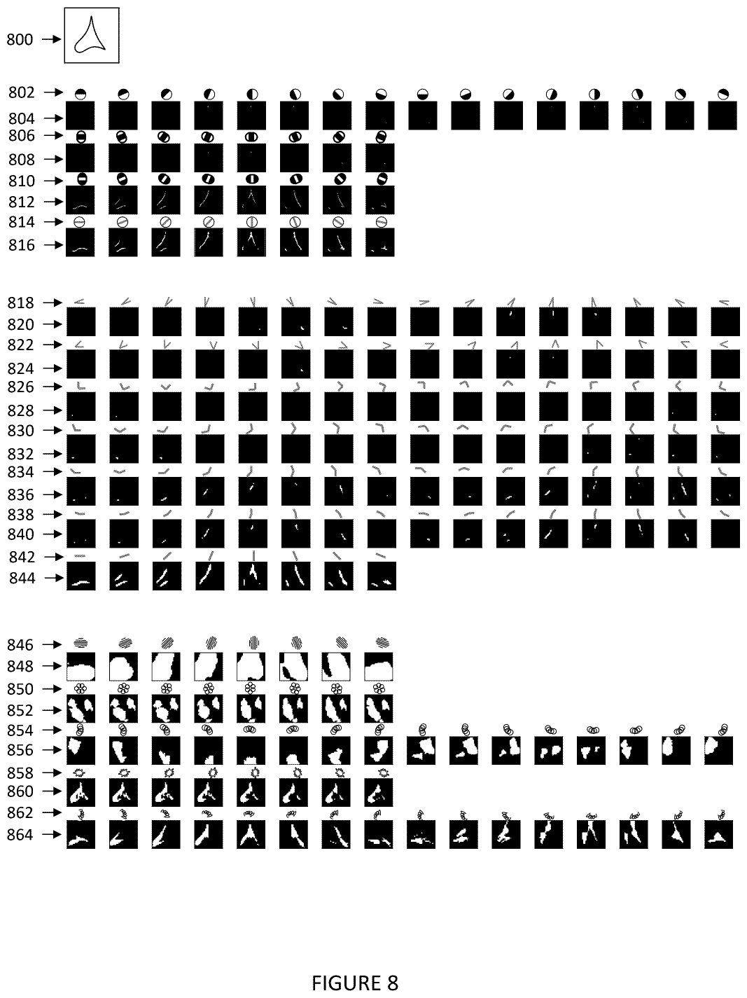

FIG. 8 shows a shape outline of inverted intensity 800: a low intensity (black) outline against a high intensity (white) background.

The output of the 16 channels of edge detection units 802 to the inverted intensity outline 800 is shown under the pictograms of the corresponding unit 804. The outputs of the edge detecting unit channels may be low or none to the outline shape 800.

The output of the 8 channels of line detection units 806 of ordinary intensity to the inverted intensity outline 800 is shown under the pictograms corresponding to each orientation in row 808. The response of the line detection units having ordinary intensity may be little or none to the inverted intensity outline FIG. 800.

The output of the 8 channels of line detection units with inverted intensity 812 units to the inverted intensity outline 800 is shown under the pictograms corresponding to each orientation in row 810.

The response 812 of line detection units with inverted intensity is substantially consistent with the shape of the input 800: Units of corresponding orientation respond at appropriate positions of the shape.

The output 816 of the 8 channels of pooling units 814 to the inverted intensity outline 800 is substantially similar to the to the output of the 8 channels of pooling units 714 to the regular intensity outline 700.

The output of the channels in later layers of the network 818-864 in response to the inverted intensity outline 800 are substantially similar to the output of the channels in the later layers of the network 718-764 in response to the regular intensity outline 700.

FIG. 9 shows a contiguous shape of ordinary intensity 900: a high intensity (white) region against a low intensity (black) background.

The output of the 16 channels of edge detection units 902 to the contiguous shape of ordinary intensity 900 is shown under the pictograms of the corresponding unit 904.

The response of the edge detection unit channels 904 to the contiguous shape 900 substantially follows the outline and orientation of the shape. The units that respond are those channels where the orientation matches the orientation of the edge of the shape, and the excitatory weights in the filter are oriented towards the center of the shape.

The output of the 8 channels of line detection units 906 of ordinary intensity to the contiguous shape of ordinary intensity 900 is shown under the pictograms corresponding to each orientation in row 908. The response of the line detection units having ordinary intensity may be little or none to the inverted intensity outline FIG. 900.

The output of the 8 channels of line detection units with inverted intensity 912 units to the contiguous shape of ordinary intensity 900 is shown under the pictograms corresponding to each orientation in row 910. The response of the line detection units with inverse intensity may be little or none to the inverted intensity outline FIG. 900.

The output 916 of the 8 channels of pooling units 914 to the contiguous shape of ordinary intensity 900 is substantially similar to the to the output of the 8 channels of pooling units 714 to the regular intensity outline 700, and substantially similar to the output of the 8 channels of pooling units 814 to the inverted intensity outline 800.

The output of the channels in later layers of the network 918-964 in response to the inverted intensity outline 900 are substantially similar to the output of the channels in the later layers of the network 718-764 in response to the regular intensity outline 700, and substantially similar to the output of the channels in the later layers of the network 814-864 in response to the inverted intensity outline 800.

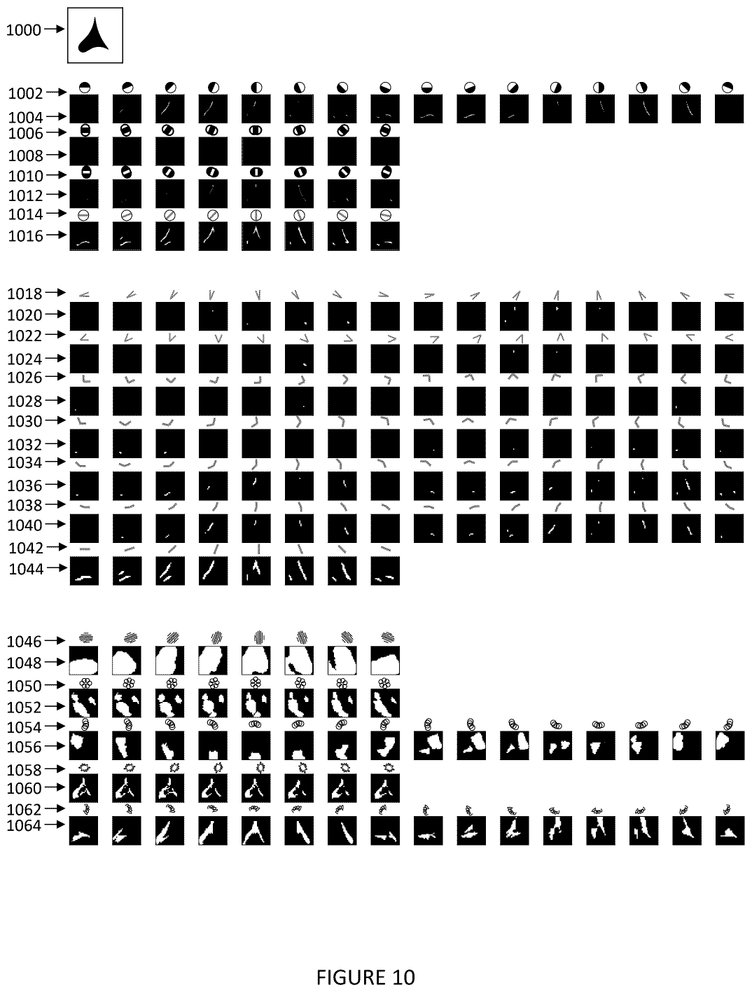

FIG. 10 shows a contiguous shape having inverted intensity 1000: a low intensity (black) region against a high intensity (white) background.

The output of the 16 channels of edge detection units 1002 to the contiguous shape having inverted intensity 1000 is shown under the pictograms of the corresponding unit 1004. The response of the edge detection unit channels 1004 to the inverted intensity shape 1000 follows the outline and orientation of the shape. The units that respond are those channels where the orientation matches the orientation of the edge of the shape, and the excitatory weights in the filter are oriented towards the outside of the shape.

The output of the 8 channels of line detection units 1006 of ordinary intensity to the contiguous shape having inverted intensity 1000 is shown under the pictograms corresponding to each orientation in row 1008. The response of the line detection units having ordinary intensity may be little or none to the inverted intensity outline FIG. 1000.

The output of the 8 channels of line detection units with inverted intensity 1012 units to the contiguous shape having inverted intensity 1000 is shown under the pictograms corresponding to each orientation in row 1010. The response of the line detection units with inverse intensity may be littler or none to the inverted intensity outline FIG. 1000.

The output 1016 of the 8 channels of pooling units 1014 to the contiguous shape having inverted intensity 1000 is substantially similar to the to the output of the 8 channels of pooling units 714 to the regular intensity outline 700, and substantially similar to the output of the 8 channels of pooling units 814 to the inverted intensity outline 800, and substantially similar to the output of the 8 channels of pooling units 914 to the contiguous shape of ordinary intensity 900.

The output of the channels in later layers of the network 1018-1064 in response to the inverted intensity outline 1000 are substantially similar to the output of the channels in the later layers of the network 718-764 in response to the regular intensity outline 700, and substantially similar to the output of the channels in the later layers of the network 814-864 in response to the inverted intensity outline 800, and substantially similar to the output of the channels in the later layers of the network 914-964 in response to the contiguous shape of ordinary intensity 900.

What is claimed is:

1. The method of claim 1 of the parent patent, wherein the first topographically organized layer of orientation-selective neurons further comprises oriented edge selective neurons and oriented line selective neurons having inverse intensity.

2. The method of claim 1 in the present continuation application, further comprising orientation-selective neurons in the first layer having selectivity for multiple sizes of their preferred oriented image feature.

3. The method of claim 2 in the present continuation application, further comprising a pooling layer in between the first orientation selective layer and the layer selective for curve segments wherein there is an aggregation function over the oriented edge selective neurons and oriented line selective neurons of regular intensity and oriented line selective neurons having inverse intensity.

4. The method of claim 8 of the parent patent, further comprising pooling layers in between one or more of the layers selective for orientations, curve segments, and curvatures created by an aggregation function over the inputs from the preceding layer.

5. The method of claim 8 of the parent patent, wherein the first topographically organized layer of orientation-selective neurons further comprises oriented edge selective neurons and oriented line selective neurons having inverse and intensity.

6. The method of claim 5 in the present continuation application, further comprising orientation-selective neurons having selectivity for multiple sizes of their preferred oriented image feature.

7. The method of claim 6 in the present continuation application, further comprising a pooling layer in between the first orientation selective layer and the layer selective for curve segments wherein there is an aggregation function over the oriented edge selective neurons and oriented line selective neurons of regular intensity and oriented line selective neurons having inverse intensity.

8. The non-transitory computer readable medium of claim 11 of the parent patent, wherein the first topographically organized layer of orientation-selective neurons further comprises oriented edge selective neurons and oriented line selective neurons having inverse intensity.

9. The non-transitory computer readable medium of claim 8 in the present continuation application, further comprising orientation-selective neurons in the first layer having selectivity for multiple sizes of their preferred oriented image feature.

10. The non-transitory computer readable medium of claim 9 in the present continuation application, further comprising a pooling layer in between the layers selective for orientations and curve segments wherein there is an aggregation function over the oriented edge selective neurons and oriented line selective neurons of regular intensity and oriented line selective neurons having inverse intensity.

11. The non-transitory computer readable medium of claim 18 in the parent application, further comprising pooling layers in between one or more of the layers selective for orientations, curve segments, and curvatures created by an aggregation function over the inputs from the preceding layer.

12. The non-transitory computer readable medium of claim 18 of the parent application, wherein the first topographically organized layer of orientation-selective neurons further comprises oriented edge selective neurons and oriented line selective neurons having inverse intensity.

13. The non-transitory computer readable medium of claim 12 in the present continuation application, further comprising orientation-selective neurons in the first layer having selectivity for multiple sizes of their preferred oriented image feature.

14. The non-transitory computer readable medium of 13 in the present continuation application, further comprising a pooling layer in between the first orientation selective layer and the layer selective for curve segments wherein there is an aggregation function over the oriented edge selective neurons and oriented line selective neurons of regular intensity and oriented line selective neurons having inverse intensity.

15. The method of claim 6 of the parent patent, wherein the convex curve segment selective units in the curve selective layer are systematically arranged symmetrically around the center of the receptive field.

16. The method of claim 6 of the parent patent, wherein the convex curve segment selective units in the curve selective layer are systematically arranged non-symmetrically around the center of the receptive field.

17. The method of claim 7 of the parent patent, wherein the concave curve segment selective units in the curve selective layer are systematically arranged symmetrically around the center of the receptive field.

18. The method of claim 7 of the parent patent, wherein the concave curve segment selective units in the curve selective layer are systematically arranged non-symmetrically around the center of the receptive field.

19. The non-transitory computer readable medium of claim 16 of the parent patent, wherein the convex curve segment selective units in the curve selective layer are systematically arranged symmetrically around the center of the receptive field.

20. The non-transitory computer readable medium of claim 16 of the parent patent, wherein the convex curve segment selective units in the curve selective layer are systematically arranged non-symmetrically around the center of the receptive field.

21. The non-transitory computer readable medium of claim 17 of the parent patent, wherein the concave curve segment selective units in the curve selective layer are systematically arranged symmetrically around the center of the receptive field.

22. The non-transitory computer readable medium of claim 17 of the parent patent, wherein the concave curve segment selective units in the curve selective layer are systematically arranged non-symmetrically around the center of the receptive field.
